(19) United States
(12) Patent Application Publication
(10) Pub. No.: US 2025/0320133 A1
(43) Pub. Date: Oct. 16, 2025

(54) WASTEWATER TREATMENT SYSTEM EXTERNAL WATER BARRIER

(71) Applicant: David A. Potts, Lyme, CT (US)

(72) Inventor: David A. Potts, Lyme, CT (US)

(21) Appl. No.: 19/174,309

(22) Filed: Apr. 9, 2025

Related U.S. Application Data
(60) Provisional application No. 63/632,223, filed on Apr. 10, 2024.

(51) Int. Cl. C02F 1/00

(52) U.S. Cl. CPC C02F 1/008; C02F 2201/002

(57) ABSTRACT

Systems, processes, apparatus, and articles of manufacture that may be configured, designed, manufactured, transported, installed or operated to provide a water barrier around an installed wastewater treatment component. The water barrier is positioned so as to retard of prevent ground water or surface water or both from entering one or more components of an installed wastewater treatment system. The water barrier in certain configurations can be partially or fully assembled prior to installation around the one or more components of the wastewater treatment system.

### TECHNICAL FIELD

External barriers for water treatment system are provided and described. More specifically, external barriers are positioned outside of water treatment tanks, conduits, access ports, etc. of a wastewater treatment system for purposes of reducing or eliminating infiltration of water into one or more components of the water treatment system.

### BACKGROUND

Water having various sources including septic wastewater, storm water, and process water (all of which may herein be collectively referred to as “water”) may be treated via a water treatment system. Water treatment systems can vary in size and scope. They can be sized for treating large amounts of water from a municipality or other large cumulative systems for benefitting many residences, businesses, and industrial facilities serviced by the municipality. Water treatment systems can also be sized for treating smaller amounts of water from local and nearby single or multiple residences and commercial facilities.

Wastewater treatment systems can comprise various components, some or all of which may be installed below ground surface. These components can include treatment tanks, infiltration fields, junction boxes, active pumps, active blowers, and connecting conduits therebetween.

In the various applications, a water treatment system may receive water to be treated from an upstream source and may pass that water through the system and ultimately discharge that water to the environment via an infiltration field or other end of line discharge configuration.

Double wall liners have been historically utilized to provide secondary containment of hazardous liquids in tanks that can be environmentally problematic. As water treatment systems are increasingly regulated and relied on to treat to higher levels, limited to certain discharge volumes for regulatory purposes and to not overload infiltration systems, control of ground water and surface water entering treatment tanks may be improved by embodiments taught herein. Many concrete and polymer treatment tanks are not well sealed and experience infiltration and inflow of groundwater, stormwater and surface water. Prevention of these water sources into tanks may be addressed by embodiments taught herein. This invention may incorporate liners, boots, seals and the like to keep water from getting into tanks.

### BRIEF DESCRIPTION OF THE DRAWINGS

FIGS. 1A-1D provides various views of a foldable polygonal exterior water barrier as may be employed in some embodiments.

FIG. 2 provides a side sectional schematic view of a portion of an exterior water barrier in relation to different wastewater treatment components that may be protected from water by the exterior water barrier as may be employed in some embodiments.

FIG. 3 provides a side sectional view of an exterior water barrier with boots surrounding a water treatment tank with manhole ports as may be employed in some embodiments.

FIGS. 4A-4B show top and side schematic views of an exterior water barrier with boots surrounding a water treatment tank with manhole ports/boots as may be employed in some embodiments.

### DETAILED DESCRIPTION

Embodiments described herein may provide how to reduce or eliminate the addition of supplemental water infiltrating into a water treatment system. Embodiments may employ various barrier configurations to retard or prevent unwanted water infiltration. These barrier configurations may be portable, foldable, flexible, and may arrive to a job site in various configurations including being partially or fully assembled on to one or more barrier protected tanks. The barriers may be made from various materials that prevent the passage of water through the barrier material. For purposes of this disclosure a waterproof or water tight material is considered to be a material that prevents the flow of water therethrough under normal operational conditions.

Barrier materials may be comprised as sheets of material folded and or bonded together to form a shape that can surround sides and a bottom and sometimes a top of a wastewater treatment system component. These barrier materials may also be formed as other shapes, such as circular boots for surrounding penetrations into or out of a treatment tank or other component of a wastewater treatment system. Alternatively boots of different materials can be affixed, glued, solvent welded, heat and sonic welding, and the like to become parts of the barrier surrounding the tank or other water treatment system component. Thus, in embodiments, liner sheets or boots or other barrier configurations may be positioned around one or more components of the water treatment system and these barrier materials may be connected with each other so as to form a waterproof barrier around the component or components that serves to protect against ground water infiltration or surface water infiltration or both. In so doing, in some embodiments, the reduction or elimination of supplemental water into the water treatment system can serve to maintain the operational fluid throughput of the water treatment system to within proper operational parameters and, perhaps, prolong the working life of the wastewater treatment system. In other words, embodiments may be employed to reduce or eliminate additional unwanted water input into the water treatment system, and, thereby may serve to prolong the useful life of the water treatment system.

Embodiments may comprise systems, processes, apparatus, and articles of manufacture that may be configured, designed, manufactured, transported, installed or operated to provide water barriers around an installed wastewater treatment component. These water barriers may be positioned so as to retard or prevent ground water or surface water or both from entering one or more components of an installed wastewater treatment system. The water barrier in certain configurations can be partially or fully assembled prior to installation around the one or more components of the wastewater treatment system to be protected. The water barriers may be waterproof upon final assembly and installation in embodiments.

Subsurface water treatment systems can employ treatment and pump tanks or other vessels to receive water for treatment and to allow solids to settle out of the water before the water exits the tank or other vessel for downstream treatment. These tanks or vessels may have fluid inlets, fluid outlets, surface access manholes, and other penetrations through their walls. The tanks or vessels may be fully or partially buried in the ground.

Embodiments may comprise various combinations of some or all of the following: Placing a barrier such as a polymer or other material liner below the tank or vessel to retard or prevent the flow of groundwater into the tank or vessel. Placing a barrier such as a polymer or other material liner around the tank or vessel to retard or prevent the flow of groundwater into the tank or vessel. Installing waterproof collars around any penetration into the tank or vessel in order to promote a waterproof seal with the waterproof collar and the surrounding barrier. Tanks and vessels are considered to be interchangeable description of the same component for purposes of this disclosure.

In embodiments, waterproof collars around any top access manholes or penetrations may reach the surface or extend past the surface to retard or prevent surface runoff from reaching the tank or vessel. The penetrations may be pre-formed or placed during installation. The waterproof collars may be premanufactured or assembled on site or sized on site or cut to size on site during installation. Exemplary tanks or vessels can include septic tanks, treatment tanks, and pump tanks, among others.

Placing a barrier, such as an exterior liner, for a tank or vessel may comprise placing a partially or fully preassembled barrier at an installation location, unfolding or opening up the barrier before, during, or after placing the barrier in the ground, and then placing a tank or vessel inside of the now open barrier. A folded barrier, such as a folded exterior liner, may look like a folded banker box prior to use and may then be unfolded to form a square or rectangle or other polygonal or round container or “tub” for acceptance of the tank or vessel.

A layer of buffer material (cushion) may be present between any barrier, e.g., liner, and a tank or vessel. The buffer material may be foam, sand, pea-stone, rubberized pellets, synthetic, foam, suitable soil backfill, as well as other material to buffer sharp edges of the tank or vessel and the liner. The buffer material may also be in sheet form or granular or chips or blocks or modules or chunks or other pieces or combinations thereof.

Barriers of embodiments may comprise generally planar sheets of material as well as nonplanar materials. These materials may be assembled partially or fully prior to installation at a job site and may be assembled on site as well. The materials of barriers may be pre-formed into shapes configured to one or more components of a water treatment system. The materials of barriers may be partially formed into shapes configured to one or more components of a water treatment system. For example, the barrier material may be configured into a rectangular liner shape whereby a rectangular treatment tank may be placed within the liner during the assembly of the water treatment system. The buffering material may be positioned between the liner and the treatment tank. As noted above, entry and exit conduits penetrating the walls of the liner and the tank may be surrounded by sleeves or boots to maintain a water retardant or water tight seal about the treatment tank. The sides of the liner or other barrier may be tall enough such that water table fluctuations are accounted for and would not in most cases overflow the perimeter walls of the liner. In certain embodiments, a top may be used with the liner or external barrier system to retard or prevent water penetration into the water treatment system.

Barriers may comprise materials that are generally considered to be impervious to water. These may include rubbers (vulcanized and unvulcanized), plastics, vinyls, as well as other materials that create a water barrier. These materials may have uniform and/or different thicknesses and one or more than one of the these or other materials may be employed in the barrier materials of embodiments.

Sections of barriers may be connected by various connection techniques. These connection techniques preferably include waterproof connections that are generally durable. Polymer welding and adhesive connection techniques (e.g., glue) may each be employed in embodiments. Mechanical connections may even be employed in areas and with techniques that provide for durable waterproof connections.

The barriers of embodiments may be flexible and may be assembled in an infiltration field or other area of a wastewater treatment system, may be assembled prior to placement, and may reside elsewhere prior to installation, e.g., be fully or partially assembled for transport, during manufacture, for on-site assembly, etc. The barrier(s) may be transportable or may also be installed at a water treatment system site ahead of final installation and hookup. External barriers may be positioned about the sides and bottom of wastewater treatment system components to retard or prevent the penetration of external water into the components.

As noted above, barriers of wastewater systems of embodiments may be assembled on site or may be manufactured off site or combinations of both. Transportable barrier components and systems may be assembled off-site and then placed at a water treatment system and partially or finally assembled, connected, and backfilled on site. Transportable barrier components and systems may be positioned between and/or within the water conveying portions of the infiltration module or in-situ infiltration field.

Barriers of embodiments may be manufactured partially or fully offsite and transported to a jobsite, for final assembly if needed, for connection to one or more other barrier components, and for final installation in a wastewater treatment system. Partially assembled barriers, folded barrier sheets, liner sheets, liner boots, liner collars, liners with some but not all welded connections, etc. Partially assembled barrier materials may be transported to a job site for connection, final assembly and connection. The final assembly and connection may include attaching conduits to water treatment systems, backfilling liners, placing cushions between liners and treatment tanks, welding liner materials together, and various other steps as well.

Embodiments may also employ water treatment systems assembled onsite. This onsite assembly can include excavation for a water treatment tank or other component, assembly of the various barrier components surrounding the tank or other component, placement of barrier, placement of a cushioning material between the barrier and the tank or other component. Placement of the tank, adding any additional barrier material, folding over edges of a barrier to cover any exposed cushioning material, making final connections of barrier material, testing the final connections of the barrier material for water tightness, making water connections, and backfilling may each also be performed individually, in various combinations and in various orders and with other steps in accordance with this disclosure.

Embodiments may comprise various combinations of the features described herein and may also include various other features consistent with the teachings provided herein as well. In some embodiments a wastewater treatment barrier system may comprise a wastewater treatment tank comprising an inlet and an outlet, where the tank may have outer side surfaces and an outer bottom surface, the outer side surfaces may each have a height. A water barrier may be positioned outside each outside side surface and the outer bottom surface, the water barrier formed as a tub around the tank in some embodiments. In some embodiments a cushioning material may be positioned between the water barrier and the outer bottom surface of the tank and in some embodiments a cushioning material may be positioned between each of the outer side surfaces of the tank and the water barrier. The water barrier may comprise a rubber or a vinyl or a plastic, each of which may be considered waterproof and in some embodiments an inlet to a treatment tank may comprise a conduit that penetrates through the water barrier. The treatment tanks of embodiments may comprise one or more manhole access and one or more riser positioned about the manhole access(es), the riser(s) having a height, and wherein an upper edge of the water barrier(s) extend(s) above the height of the riser(s). In some embodiments, a treatment tank may comprise concrete or fiberglass or carbon composites. In certain embodiments the liner is secured to the manhole risers and other penetrations, in others it is not and simply extends up to an elevation higher than groundwater. In certain embodiments liners are extended above the highest possible groundwater elevation and sealed above the tank to prevent surface water and stormwater from entering the liner and ultimately the tank or other protected wastewater treatment system component.

In some embodiments a wastewater treatment barrier system may comprise a plurality of components of a subsurface wastewater treatment system; and a water barrier tub positioned around the plurality of components, which, when installed in the ground, the water barrier tub may be configured to prevent groundwater from penetrating into any of the plurality of components. In some embodiments, a cushioning material may be positioned within the water barrier tub and a cushioning material positioned outside of the water barrier tub. In some embodiments the barrier tub or other barrier may comprise at least one of rubber or plastic or vinyl. In some embodiments the barrier tub or other barrier may comprise a polygonal shape and may have a plurality of fold lines. In some embodiments the barrier tub or other barrier is repositionable from a folded position to an unfolded position, the folded position unable to receive the plurality of components and the unfolded position sized to accept the plurality of components within the tub or other barrier. In some embodiments the wastewater treatment system components may comprise a treatment tank, the tank having a height, and wherein a height of a side wall of the tub is taller than the height of the treatment tank. Rigid or flexible tubs can be constructed as a tank around a tank. Tubs can be installed around the primary tank and the interstitial space dewatered to prevent water from entering the primary tank. Cushioning material may be placed in the interstitial space.

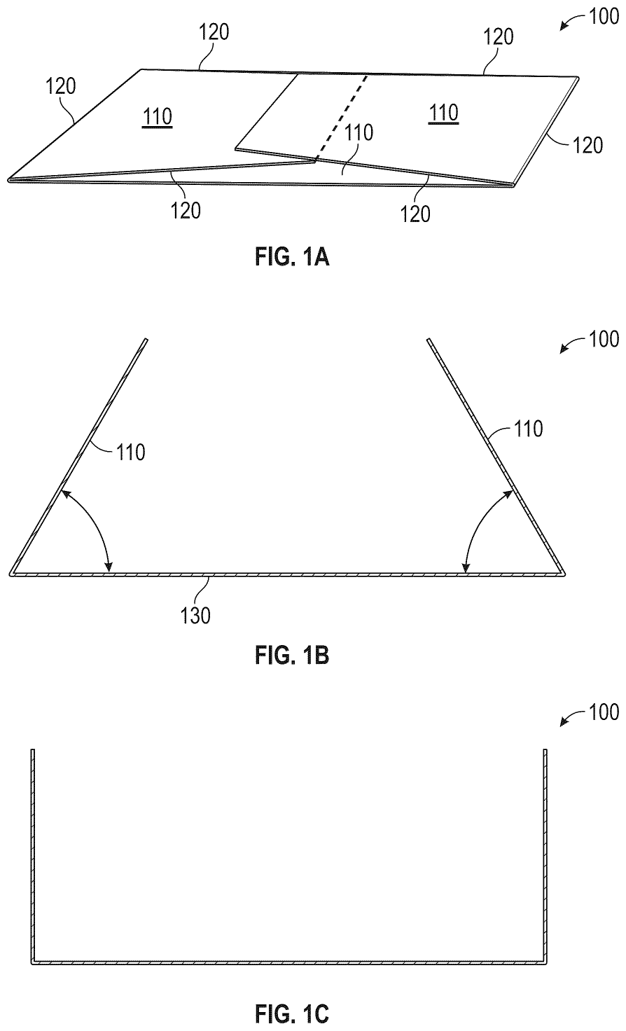

FIGS. 1A-1D provides various views of a foldable polygonal exterior water barrier as may be employed in some embodiments. FIG. 1A shows the barrier 100 in a folded configuration where each of the four walls 110 are folded down into a compact position. This sideview of the barrier 100 shows how a compact folded configuration of the barrier can be useful for transportation of the barrier 100 prior to installation. Seams 120 between each of the various walls 110 or bottom comprising the barrier may be folds made in a larger sheet of material or actual connections between panels of different sheets of material. The connections between walls or bottom (i.e. panels) may be made through heat welding, chemical welding, glue, or other waterproof connection techniques.

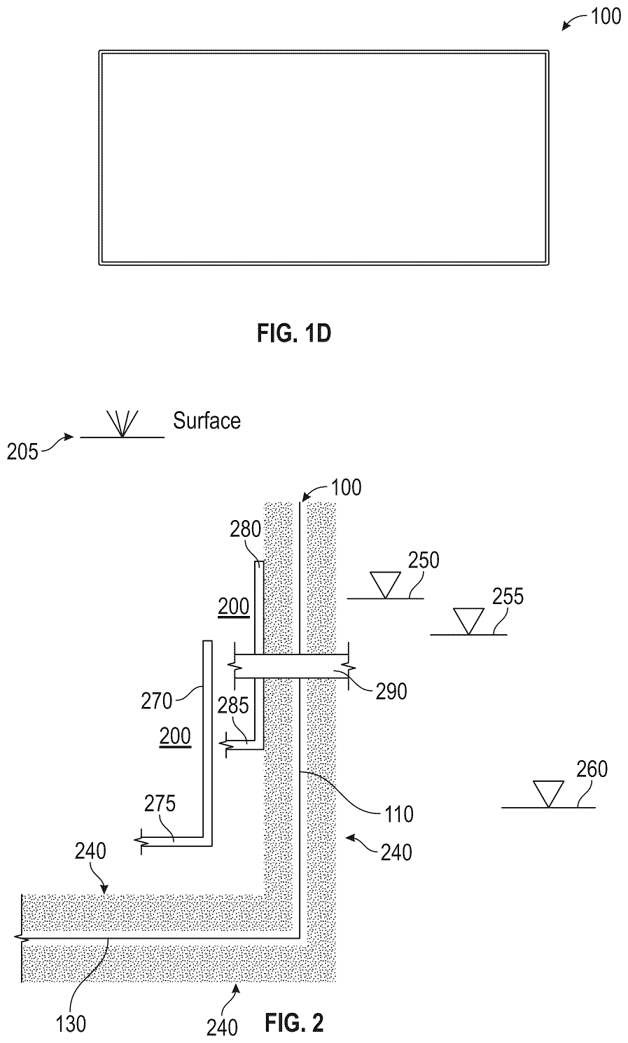

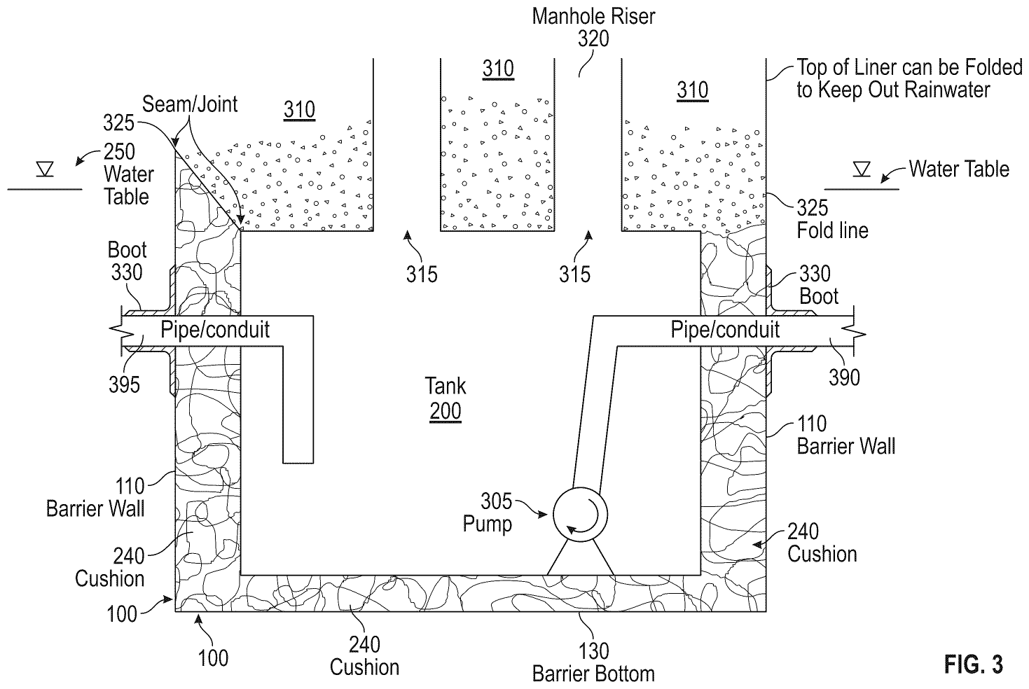

FIG. 1B shows a cross-section of the barrier 100 in a partially unfolded configuration where walls 110 and bottom 130 are labelled. As can be seen in FIG. 1B the walls 110 are about the same size and are long enough to overlap each other in a folded configuration. The top edges of the walls may be folded down in some embodiments to cover a space between the barrier and the component, which may be contain or be filled with a cushion material. FIGS. 2 and 3 show this cushion material. The cushion material may comprise various materials and may be suitable to inhibit or prevent puncture or tearing of the barrier material. The cushion material may be inside the barrier or outside the barrier or both. Cushion material may be installed in embodiments at various stages of installation including after tank placement, after dewatering (if necessary), after water conduit placement, after final barrier assembly, before final barrier assembly, and at other times as well.

FIG. 1C shows a cross-section of the barrier 100 in an unfolded configuration. As can be seen in this and other figures the barrier 100 may comprise a relatively thin liner material that is generally planar in shape. Nonplanar liner materials and nonplanar other materials may also be used in embodiments to form the walls or bottom or top of the barrier. Nonplanar materials may include cuspated materials, wavy materials, curved materials, crenellated materials as well as others.

FIG. 1D is a top down view of the barrier 100 and shows how the fully opened barrier 100 may form a tub in which a treatment tank or other component of a wastewater treatment system may reside. There is no top shown in FIGS. 1A-1D although some embodiments may have a top on the barrier. The height of the walls may be sized in embodiments such that ground water cannot overspill into the tub and reach the tank or other component in the barrier. Likewise, if the walls are tall enough or a top is added, the barrier can be configured to inhibit or stop surface water or water from above from reaching the tank or other component in the barrier 100.

FIG. 2 provides a side sectional schematic view of a portion of an exterior water barrier 100 in relation to different wastewater treatment components that may be protected from water by the exterior water barrier, as may be employed in some embodiments. The high ground water level 250, interim ground water level 255, and low ground water level 260 are shown outside of the barrier 100. The barrier 100 is shown with walls 110 and bottom 130 in this partial sectional view. Internal tank wall 280 and bottom 285 are labelled along with output conduit 290. As can be seen in FIG. 2, the output conduit 290 pierces through wall 110 and wall 280 and is positioned below ground water level 250 and ground water level 255. Thus, in two ground water conditions the conduit 290 protruding from the wall 280 would be submerged in ground water but for the barrier 100. Also notable is that the top of the wall 280 sits above the high ground water level 250, so in this instance the height of the wall 110 would not serve to prevent groundwater spill over into the tank. Comparably, the height of the wall 270 of another plausible tank location in embodiments is below the high ground water level 250, so in this instance the barrier wall 110 does serve to prevent ground water from spilling into the tank when positioned at this lower invert elevation from the surface 205. The bottom 285 is shown to be higher than the low groundwater level 260 while the bottom 275 is shown to be below the low groundwater level 260. Accordingly, the lower tank location would sit in ground water while the higher tank location would intermittently sit in groundwater depending on the time of year and the relative location of the water table. Exemplary elevations may place the bottom of a tank or other component at 100 while the barrier side wall top may reside at 110 and the ground water may have a high mark of 107 while surface grade may be at 115. In this example, a three foot buffer is present in height of the barrier side wall when compared to the opening of the component being protected by the barrier. In instances where groundwater spills over the top of the liner, the space between the liner and the tank can be dewatered. It is most desirable to not allow groundwater to overtop the tub or liner.

Cushioning material 240 is shown inside and outside the barrier 100 including above and below bottom 130 and inside and outside of wall 110. The cushioning material may be present in some, none, or all of these locations in embodiments. As noted herein, the cushioning material may comprise various materials and may function to retard or prevent damage to the barrier walls, top bottom, etc.

In embodiments, water sensors may be placed in various positions of the barrier and the cushioning and the component to monitor the effectiveness of the barrier. If water is detected in the cushioning, for example, an operator may make operational changes to the wastewater treatment system to accommodate this additional infiltrating ground water.

FIG. 3 provides a side sectional view of an exterior water barrier with boots 330 surrounding a water treatment tank 200 with manhole ports 315 and risers 320 as may be employed in some embodiments. The top of the barrier walls 110 are shown folded over at 325. By folding the barrier walls in this fashion, the cushioning material 240 may be kept dry or reasonably dry from ground water intrusion and rain water intrusion. Fill 310 is shown above the tank 200 and outside of the manhole risers 320. The water table high level is labelled 250 while the pipe conduit is labelled 395, Pump is labelled 305 and exit conduit pipe is labelled 390. As can be seen in FIG. 3, the tank 200 is protected from ground water infiltration via the barrier walls 110 and bottom 130 and the manhole risers 320. As noted above, the boots 330 may be mechanically or chemically adhered to the barrier walls 110. As also noted in FIG. 3, by folding over the top of the walls 110 rainwater or other surface water may be kept from the interstitial space, which may be occupied by cushioning material, between the barrier 100 and the tank 200.

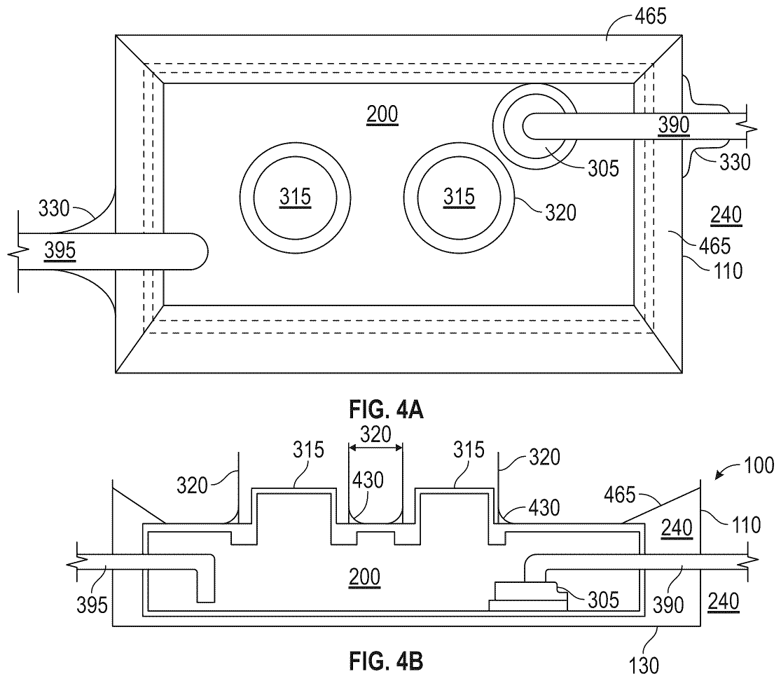

FIGS. 4A-4B show top and side schematic views of an exterior water barrier with boots surrounding a water treatment tank with manhole ports as may be employed in some embodiments. Labelled in FIGS. 4A-4B are barrier 100, barrier walls 110, barrier bottom 130, interstitial space cover 465, cushioning material 240, manhole portal 315, manhole riser 320, manhole boot 430, boot 330, conduit pipe 390, conduit pipe 395, pump 305, and tank 200. In FIGS. 4A-4B the interstitial space cover 465 is made from the same material as barrier wall 110. This cover 465 may be welded to or otherwise connected in a waterproof manner to the walls 110 of the barrier 100. A water proof connection may also be present between the cover 46 and the top of the tank 200. FIG. 4B shows the relative proportions between the height of the side walls 110 and the height of the tank 200 or other component that may be within the barrier 100. FIG. 4B also shows how the barrier 100 can be formed as a tub and the component, in this instance a tank 200, can be positioned within the tub. In use, anticipated ground water fluctuations would remain below the height of the side walls 110 so that groundwater may not overspill onto the top of the tank 200. Nevertheless, if water did reach the top of the tank, the presence of the barrier manhole risers 320 would serve to retard water from reaching the manhole portal 315.

Some embodiments may comprise using the processes, systems, articles of manufacture, or apparatus with or in wastewater systems that comprise: a processing/treatment vessel; a distribution system; and an infiltration system comprising an infiltration field, monitoring ports, and carbon addition ports. Some embodiments may comprise using the processes, systems, articles of manufacture, or apparatus with or in infiltration systems comprising infiltration fields comprised of stone, sand, hollow structures, man-made materials and/or synthetic media including geotextiles. Some embodiments may comprise using the processes, systems, articles of manufacture, or apparatus with or in wastewater systems installed directly in native or imported soils. Some embodiments may comprise using the processes, systems, articles of manufacture, or apparatus with or in wastewater systems that include a secondary treatment vessel, such as but not limited to, a treatment unit. Some embodiments may comprise using the processes, systems, articles of manufacture, or apparatus with or in wastewater infiltration field(s) with a surface area to void space ratio of approximately <0.5. Some embodiments may comprise using the processes, systems, articles of manufacture, or apparatus with or in wastewater infiltration field(s). Some embodiments may comprise using the processes, systems, articles of manufacture, or apparatus with or in wastewater treatment systems that may be surrounded by the following soils:
Sands: silt+(1.5*clay)<15%
Loamy sands: silt+1.5*clay>=15% and silt+2*clay<30%
Sandy loams: clay>=7% and clay<20% and sand >52% and silt+2*clay>=30% OR clay<7% and silt<50% and silt+2*clay>=30%)
Loam: clay>=7% and clay<27% and silt>=28% and silt<50% and sand <=52%
Silt Loam: silt>=50% and clay>=12% and clay<27% OR silt>=50% and silt<80% and clay<12%
Silt: silt>=80% and clay<12%
Sandy Clay Loam: clay>=20% and clay<35% and silt<28% and sand >45%
Clay Loam: clay>=27% and clay<40% and sand >20% and sand <=45%
Silty Clay Loam: clay>=27% and clay<40% and sand <=20%
Sandy Clay: clay>=35% and sand >45%
Silty Clay: clay>=40% and silt>=40%
Clay: clay>=40% and sand <=45% and silt<40%

Some embodiments may comprise using the processes, systems, articles of manufacture, or apparatus with or in wastewater systems that have stone, cobbles, gravel, ledge, bedrock, or soil parent material as the native material surrounding the system. Some embodiments may comprise using the processes, systems, articles of manufacture, or apparatus with or in wastewater systems that have engineered media, such as specified sand or gravel/stone, as the material surrounding the system. Some embodiments may comprise using the processes, systems, articles of manufacture, or apparatus with or in wastewater systems that include passive remediation infrastructure including, but not limited to, a constructed wetland, sand filters, gravel filters, waste stabilizing pond/lagoon, collection basin, rain garden, retention/detention areas, vegetated or dry swales, or underground detention systems. Some embodiments may comprise using the processes, systems, articles of manufacture, or apparatus with or in wastewater systems that include vegetation pollutant removal, such as, but not limited to, rain gardens, bioswales, and evapotranspiration systems driven by such species as Salix or Phragmites. Some embodiments may comprise using the processes, systems, articles of manufacture, or apparatus with or in wastewater systems that are covered with sand, imported or native soil. Some embodiments may comprise using the processes, systems, articles of manufacture, or apparatus with or in wastewater systems that are covered with permeable or impermeable asphalt/pavement. Some embodiments may comprise using the processes, systems, articles of manufacture, or apparatus with or in wastewater systems that open to the atmosphere. Some embodiments may comprise using the processes, systems, articles of manufacture, or apparatus with or in wastewater systems that are located above grade.

Some embodiments may comprise using the processes, systems, articles of manufacture, or apparatus with or in wastewater systems that serve single residences, multi-family residences, commercial businesses, public organizations/property, private organizations/property, government buildings, and any other situation where onsite wastewater treatment is used.

Some embodiments may comprise using the processes, systems, articles of manufacture, or apparatus with or in community based onsite wastewater treatment systems and any soil or water-based treatment systems serving as intermediate or final treatment or dispersal for wastewater treatment plants.

Some embodiments may comprise using the processes, systems, articles of manufacture, or apparatus with or in systems that employ a geotextile fabric within and/or around the barrier. The geotextile fabric may stabilize the sediment during treatment to avoid soil stratification by particle size.

Embodiments may be employed when a system is restricted or failing to treat and disperse wastewater. Embodiments may be employed when a system is overloaded with wastewater/stormwater and/or organic matter, causing low levels of oxygen within an infiltration field (which may occur either or both because microbial decomposition of organic matter consumes oxygen and because the oxygen concentrations in water are many thousands of times lower than oxygen concentrations in air). These situations may occur when a system is heavily used, the infiltration field is relatively undersized, or if there is an addition of materials to the system that are noncompatible with treatment in the infiltration system. Embodiments may be employed when a system is operating normally, or close to normally, and it is desirable to inhibit or prevent restriction or failing.

The preceding detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” of “in embodiments” do not necessarily refer to the same embodiment. Particular features, structures, or characteristics may be combined in any suitable manner consistent with this disclosure.

While embodiments have been illustrated herein, they are not intended to restrict or limit the scope of the appended claims to such detail. In view of the teachings in this application, additional advantages and modifications will be readily apparent to and appreciated by those having ordinary skill in the art. Accordingly, changes may be made to the above embodiments without departing from the scope of the invention. Likewise, above embodiments may be combined partially or fully in various ways without departing from the scope of the invention.

The terminology used herein is for the purpose of describing particular embodiments only and is not intended to be limiting of the invention. As used herein, the singular forms “a,” “an” and “the” are intended to include plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “about” or “approximately” in reference to a recited numeric value, including for example, whole numbers, fractions, and/or percentages, generally indicates that the recited numeric value encompasses a range of numerical values (e.g., +/−5% to 10% of the recited value) that one of ordinary skill in the art would consider equivalent to the recited value (e.g., performing substantially the same function, acting in substantially the same way, and/or having substantially the same result). As used herein, the terms “about” or “approximately” in reference to a recited non-numeric parameter generally indicates that the recited non-numeric parameter encompasses a range of parameters that one of ordinary skill in the art would consider equivalent to the recited parameter (e.g., performing substantially the same function, acting in substantially the same way, and/or having substantially the same result).

Recitation of ranges of values herein are merely intended to serve as a shorthand method of referring individually to each separate value falling within the range, unless otherwise indicated herein, and each separate value is incorporated into the specification as if it were individually recited herein.

“First,” “Second,” etc. As used herein, these terms are used as labels for nouns that they precede, and do not imply any type of ordering (e.g., spatial, temporal, logical, etc.). For example, reference to a “first” item does not necessarily imply that this item is the item in a sequence; instead, the term “first” is used to differentiate this item from another item (e.g., a “second” item).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

The scope of the present disclosure includes any feature or combination of features disclosed herein (either explicitly or implicitly), or any generalization thereof, regardless of whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The corresponding structures, material, acts, and equivalents of any means or steps plus function elements in the claims are intended to include any structure, material or act for performing the function in combination with other claimed elements. The description of certain embodiments of the present invention have been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

What is claimed is:

1. A wastewater treatment or pump tank barrier system comprising:
a wastewater tank comprising an inlet and an outlet, the tank having outer side surfaces and an outer bottom surface, the outer side surfaces each having a height; and
a water barrier positioned outside each outside side surface and the outer bottom surface, the water barrier formed as a tub around the tank.

2. The wastewater treatment or pump tank barrier system of claim 1 further comprising:
a cushioning material positioned between the water barrier and the outer bottom surface of the tank.

3. The wastewater treatment or pump tank barrier system of claim 1 further comprising:
a cushioning material positioned between each of the outer side surfaces of the tank and the water barrier.

4. The wastewater treatment or pump tank barrier system of claim 1 wherein the water barrier comprises a rubber or a vinyl or a plastic.

5. The wastewater treatment or pump tank barrier system of claim 1 wherein the inlet comprises a conduit that penetrates through the water barrier.

6. The wastewater treatment or pump tank barrier system of claim 1 wherein the tank further comprises a manhole access and a riser positioned about the manhole access, the riser having a height, and wherein an upper edge of the water barrier extends above the height of the riser.

7. The wastewater treatment or pump tank barrier system of claim 1 wherein the tank comprises concrete.

8. A wastewater treatment barrier system comprising:
a plurality of components of a subsurface wastewater treatment system;
a water barrier tub positioned around the plurality of components, when installed in the ground, the water barrier tub configured to prevent groundwater from penetrating into any of the plurality of components.

9. The wastewater treatment barrier system of claim 8 further comprising:
a cushioning material positioned within the water barrier tub.

10. The wastewater treatment barrier system of claim 8 further comprising:
a cushioning material positioned outside of the water barrier tub.

11. The wastewater treatment barrier system of claim 8 wherein the barrier tub comprises at least one of rubber or plastic or vinyl.

12. The wastewater treatment barrier system of claim 8 wherein the barrier tub comprises a polygonal shape and has a plurality of fold lines.

13. The wastewater treatment barrier system of claim 8 wherein the barrier tub is repositionable from a folded position to an unfolded position, the folded position unable to receive the plurality of components and the unfolded position sized to accept the plurality of components within the tub.

14. The wastewater treatment barrier system of claim 8 wherein the plurality of components comprises a treatment tank, the tank having a height, and wherein a height of a side wall of the tub is taller than the height of the treatment tank.

15. The wastewater treatment barrier system of claim 8 further wherein the tub comprises a waterproof boot, the boot positioned around an inlet or outlet passing through the tub.

16. The wastewater treatment barrier system of claim 8 wherein the plurality of components of the subsurface wastewater treatment system comprises a tank and an access manhole on the tank, and wherein the tub is secured around the access manhole using a boot.
